(19) United States
(12) Patent Application Publication
(10) Pub. No.: US 2016/0203529 A1
(43) Pub. Date: Jul. 14, 2016

(54) Billing Method for Lighting Equipment

(71) Applicant: LUXUL TECHNOLOGY INCORPORATION, New Taipei City (TW)

(72) Inventors: Cheng-Hung Pan, New Taipei City (TW); Eric Wen-Chien Chen, New Taipei City (TW); Perng-Fei Yuh, New Taipei City (TW); Chih-Hung Lin, New Taipei City (TW)

(21) Appl. No.: 14/715,701

(22) Filed: May 19, 2015

(30) Foreign Application Priority Data
Jan. 14, 2015 (TW) 104101139

(51) Int. Cl. G06Q 30/04; G06Q 50/06

(52) U.S. Cl. CPC G06Q 30/04; G06Q 50/06

(57) ABSTRACT

A billing method for lighting equipment includes steps of installing an electricity consumption meter, recording the power of first lighting equipment and transmitting the power of the first lighting equipment to a billing server, replacing the first lighting equipment with second lighting equipment, recording power of the second lighting equipment and transmitting the power of the second lighting equipment to a billing server, calculating a billing parameter using the billing server according to a difference between the power of the first lighting equipment and the power of the second lighting equipment and further calculating a saved charge for billing fairness. Besides, as the amount of electricity consumed by the second lighting equipment is directly sent to the billing server, lighting equipment suppliers can directly collect reasonable service charge from customers without requiring electric bills provided by the customers.

### BACKGROUND OF THE INVENTION

1. Field of the Invention

The present invention relates to a billing method and, more particularly, to a billing method for lighting equipment.

2. Description of the Related Art

After being manufactured, current lighting equipment is distributed through wholesalers to retailers for sale to consumers. Consumers can go to a local retailer to buy the lighting equipment when they have the demand for lighting equipment.

LED (Light-emitting diode) lighting equipment prevails in current lighting market because of the advantages of being more power-saving, brighter, and prolonged durability. However, production cost of LED lighting equipment is rather high and the cost is in turn passed on to the retail price thereof, making people reluctant in purchasing the LED lighting equipment or replacing current lighting equipment with the LED lighting equipment.

To tackle that reluctance, LED lighting equipment suppliers provide a billing means for using LED lighting equipment. The billing means collects a specific percentage of the saved charge of a customer's electric bill as a service charge after the customer's current lighting equipment is replaced by LED lighting equipment, so as to compensate the retail price of the LED lighting equipment. However, from the perspective of customers, it is not transparent to know if the service charge billed by the LED lighting equipment suppliers is a justifiable amount.

Moreover, if customers are unwilling to provide the electric bill, there is no way that LED lighting equipment suppliers can calculate the service charge and bill the customers. Accordingly, the current billing means fails to provide a fair billing scheme for both suppliers and customers.

### SUMMARY OF THE INVENTION

An objective of the present invention is to provide a billing method for lighting equipment for improving unfairness caused between electricity supplier and customers in terms of current billing means.

To achieve the foregoing objective, the billing method for lighting equipment comprises steps of:

installing an electricity consumption meter;

recording the power of first lighting equipment with the electricity consumption meter and transmitting the power of the first lighting equipment to a billing server through the Internet;

replacing the first lighting equipment with second lighting equipment;

recording power of the second lighting equipment with the electricity consumption meter and transmitting the power of the second lighting equipment to a billing server through the Internet, wherein the power of the first lighting equipment is greater than the power of the second lighting equipment;

calculating a billing parameter using the billing server according to the power of the first lighting equipment and the power of the second lighting equipment;

recording an amount of consumed electricity of the second lighting equipment in a unit time with the electricity consumption meter, and transmitting the amount of consumed electricity to the billing server; and

calculating a service charge using the billing server according to the billing parameter and the amount of consumed electricity of the second lighting equipment in the unit time.

Because the second lighting equipment is more power-saving than the first lighting equipment, the power of the second lighting equipment is less than the power of the first lighting equipment and customers can save power from replacement of the first lighting equipment with the second lighting equipment. The billing parameter is calculated according to the power of the first and second lighting equipment detected by the electricity consumption meter. It is fair for both the lighting equipment supplier and the customers to be aware of the difference of power through the electricity consumption meter, which can be used to calculate a saved charge from the difference of power. Meanwhile, the lighting equipment supplier can acquire the amount of consumed electricity of the second lighting equipment in a unit time and further calculate the service charge as a reasonable service charge to be collected.

To achieve the foregoing objective, a billing method for lighting equipment is performed by a billing server connected to first lighting equipment or second lighting equipment through the Internet, and the billing method includes steps of:

receiving power from first lighting equipment through the Internet;

receiving power from second lighting equipment through the Internet, wherein the second lighting equipment replaces the first lighting equipment, and the power of the first lighting equipment is greater than the power of the second lighting equipment;

calculating a billing parameter according to the power of the first lighting equipment and the power of the second lighting equipment;

receiving an amount of consumed electricity of the second lighting equipment in a unit time through the Internet; and

calculating a service charge according to the billing parameter and the amount of consumed electricity of the second lighting equipment in the unit time.

As the billing server can acquire the power of the first lighting equipment and the power of the second lighting equipment and calculate the billing parameter according to the power of the first and second lighting equipment and use the billing parameter as a criterion for the service charge, the lighting equipment supplier and the customers can be all aware of the power of the first and second lighting equipment and it is an open and fair platform for both sides to assess whether the billing parameter is reasonable. When receiving the amount of electricity consumed by the second lighting equipment during a unit time, the billing server can accurately calculate the service charge. Therefore, even though the customers are unwilling to provide electric bills, the lighting equipment supplier can still fairly and clearly calculate the reasonable service charge to be collected from the customers.

Other objectives, advantages and novel features of the invention will become more apparent from the following detailed description when taken in conjunction with the accompanying drawings.

### BRIEF DESCRIPTION OF THE DRAWINGS

FIGS. 1A and 1B are two continuous portions of a flow diagram of a first embodiment of a billing method for lighting equipment in accordance with the present invention;

FIGS. 2A and 2B are functional block diagrams illustrating operation of billing hardware architecture in accordance with the present invention; and

FIGS. 3A and 3B are two continuous portions of a flow diagram of a second embodiment of a billing method for lighting equipment in accordance with the present invention.

### DETAILED DESCRIPTION OF THE INVENTION

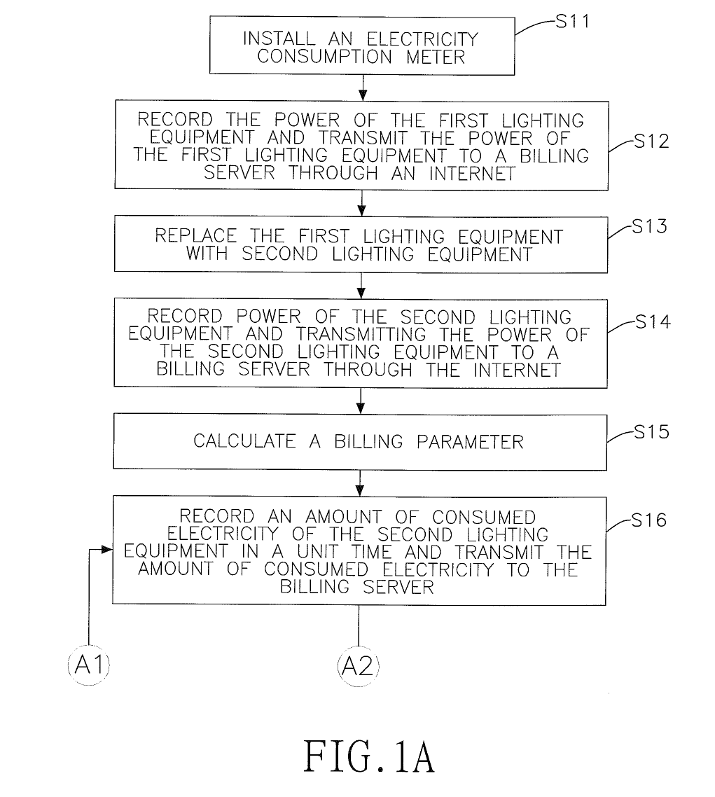

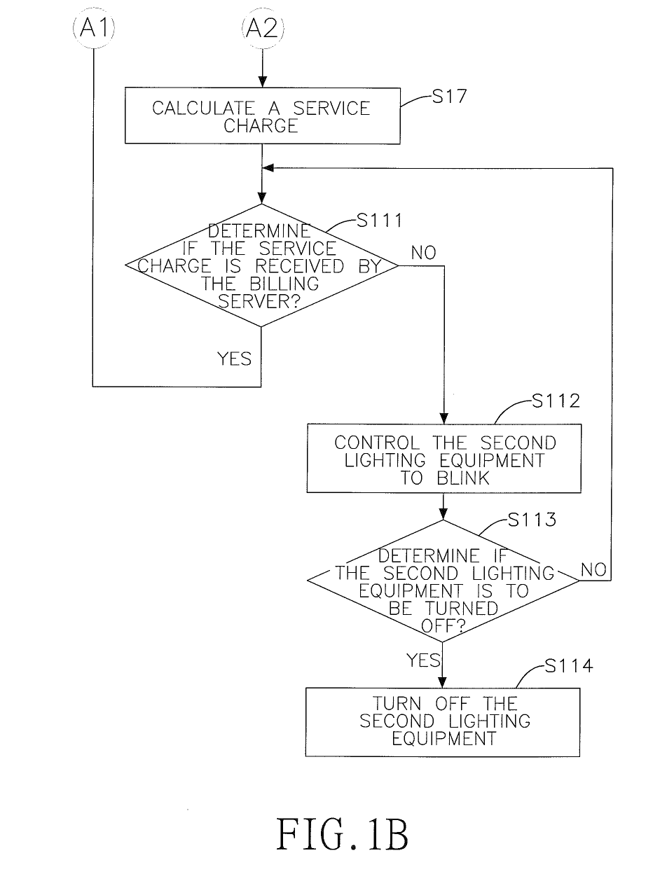

With reference to FIGS. 1A and 1B, a first embodiment of a billing method for lighting equipment in accordance with the present invention includes the following steps.

Step S11: Install an electricity consumption meter.

Step S12: Record the power of first lighting equipment with the electricity consumption meter and transmit the power of the first lighting equipment to a billing server through the Internet.

Step S13: Replace the first lighting equipment with second lighting equipment.

Step S14: Record power of the second lighting equipment with the electricity consumption meter and transmit the power of the second lighting equipment to the billing server through the Internet. The power of the first lighting equipment is greater than the power of the second lighting equipment.

Step S15: Calculate a billing parameter using the billing server according to the power of the first lighting equipment and the power of the second, lighting equipment.

Step S16: Record an amount of consumed electricity of the second lighting equipment in a unit time with the electricity consumption meter, and transmit the amount of consumed electricity to the billing server.

Step S17: Calculate a service charge using the billing server according to the billing parameter and the amount of consumed electricity of the second lighting equipment in the unit time.

To perform the foregoing method, the electricity consumption meter is first installed to record the power of the original first lighting equipment of a customer, and the first lighting equipment is replaced by the second lighting equipment provided by a lighting equipment supplier. The second lighting equipment is chosen to be more power-saving than the first lighting equipment. The electricity consumption meter is further used to record the power of the second lighting equipment. As the electricity consumption meter is used to detect the power of the first lighting equipment and the second lighting equipment, the customer and the lighting equipment supplier can both directly access the power of the first lighting equipment and the second lighting equipment to ascertain a saving amount of consumed electricity after replacing the first lighting equipment with the second lighting equipment and ensure a fair billing scheme.

Besides, the lighting equipment supplier can inquire total consumed electricity in the unit time of the second lighting equipment and further calculate the service charge. Even though the customer fails to provide the electric bill, the lighting equipment supplier can still acquire a correct billing charge to collect the service charge from the customer.

Furthermore, prior to step S11, personnel of the lighting equipment supplier visit a customer's premise, such as a residence, an office or a factory, for a site survey of the lighting equipment to be replaced to assess whether it is appropriate for installation of the electricity consumption meter, such as installation of a wireless router for all electricity consumption meters to wirelessly connect to the wireless router further transmitting information to the billing server through the Internet. If the site survey is assessed to be good for replacement of the lighting equipment, the lighting equipment supplier will come to the site to install the electricity consumption meter.

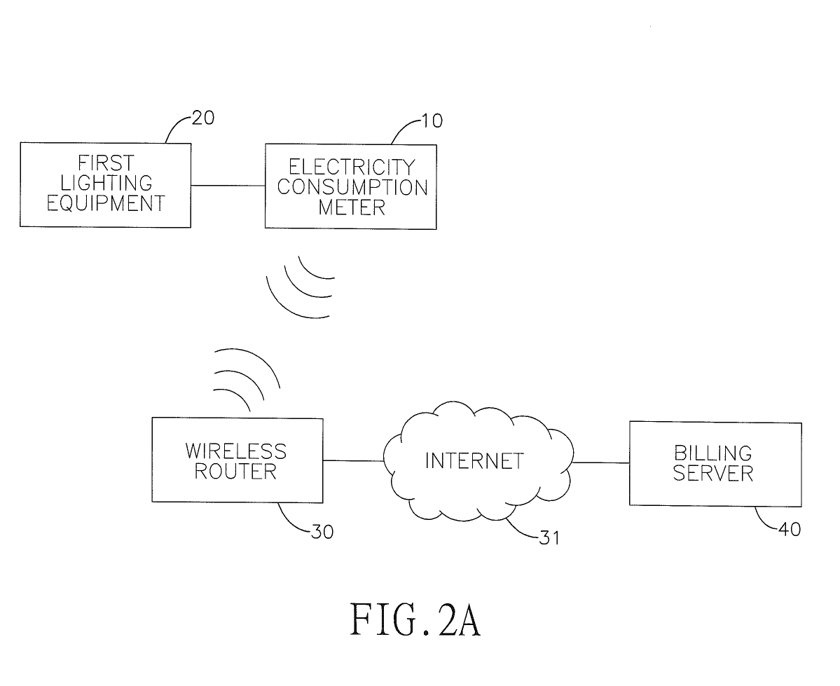

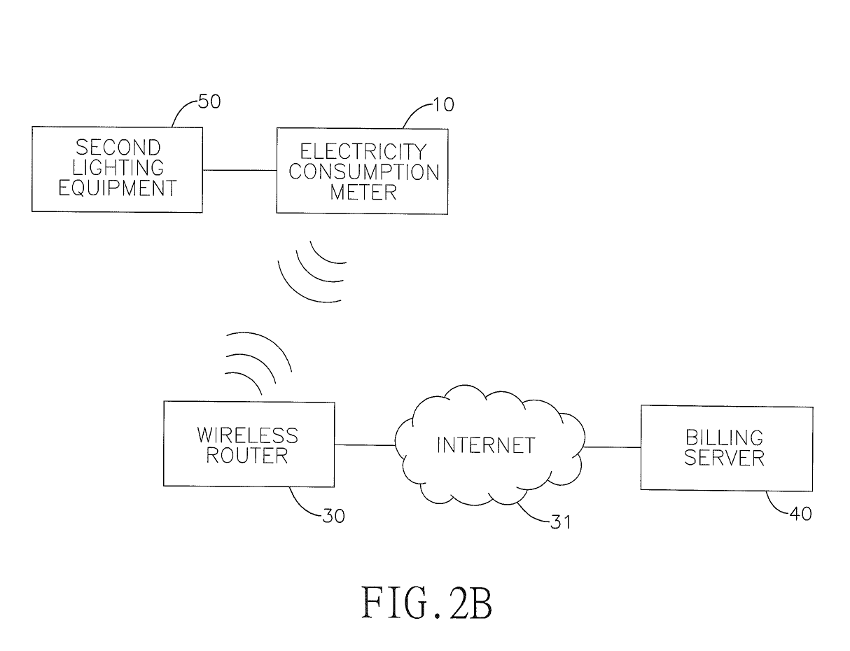

With reference to FIG. 2A, in step S12 the electricity consumption meter 10 is electrically connected to the first lighting equipment 20 to detect the power of the first lighting equipment 20, and after the electricity consumption meter 10 is wirelessly connected to a wireless router 30, the wireless router 30 further transmits the power of the first lighting equipment 20 to the billing server 40 through the Internet 31.

With reference to FIG. 2B, in step S13 the first lighting equipment 20 is replaced by the second lighting equipment 50 that is more power-saving. In step S14 the electricity consumption meter 10 detects the power of the second lighting equipment 50 instead of the first lighting equipment 20 since the first lighting equipment 20 is replaced by the second lighting equipment 50, and is wirelessly connected to the wireless router 30 that is connected to the billing server 40 through the Internet 31 to further transmit the power of the second lighting equipment to the billing server 40. On the other hand, the billing server 40 can remotely control the electricity consumption meter 10 through the Internet 31 to turn on or off the second lighting equipment 50.

In step S15 the billing server 40 calculates the billing parameter according to the following equation.

$$A = \frac{P 1 - P 2}{P 2}$$

where

A: the billing parameter;

P1: the power of the first lighting equipment (Watt);

P2: the power of the second lighting equipment (Watt).

In step S16 the electricity consumption meter 10 further detects the amount of consumed electricity of the second lighting equipment 50 in the unit time, and transmits the amount of consumed electricity of the second lighting equipment 50 to the billing server 40 through the wireless router 30 and the Internet 31. Given one month as an example of the unit time, the electricity consumption meter 10 detects a total charge of consumed electricity of the second lighting equipment 50 in a month, and the unit of electricity for consumed electricity is kilowatt-hour (kW-h). In step S17 the billing server 40 calculates the saved charge according to the billing parameter and the total charge of consumed electricity of the second lighting equipment 50 in the unit time. The saved charge is calculated according to the following equation.

$$Y = C \times A \times B = C \times \frac{P 1 - P 2}{P 2} \times B$$

where

Y: the saved charge out of a total charge of consumed electricity (kW-h) of the second lighting equipment in the unit time;

A: the billing parameter;

B: a billing charge per unit of electricity (dollar/kW-h);

C: the total charge of consumed electricity (kW-h) of the second lighting equipment in the unit time;

P1: the power of the first lighting equipment (Watt);

P2: the power of the second lighting equipment (Watt).

The saved charge of electric bill of the customer during the unit time after the first lighting equipment is replaced by the second lighting equipment can be thus calculated. The lighting equipment supplier only relies on the charge saved from the customer's electric bill as a result of the replacement of lighting equipment and provides warranty to the customer for inspection and maintenance of the second lighting equipment without additionally charging the customers for materials and labor required in services, thereby creating a win-win situation for both customers and lighting equipment suppliers.

Basically, instead of taking the entire saved charge Y, the lighting equipment supplier only takes a specific percentage Z out of the saved charge Y as a service charge X to be collected from the customer. Thus, the remaining saved charge is rewarded to the customer as an incentive to encourage customers' willingness in replacing existing lighting equipment. The service charge can be calculated according to the following equation.

$$X = Z \times Y = Z \times C \times A \times B = Z \times C \times \frac{P 1 - P 2}{P 2} \times B$$

Where

X: the service charge;

Y: the saved charge out of a total charge of consumed electricity (kW-h) of the second lighting equipment in the unit time;

Z: the specific percentage of the saved charge collected by lighting equipment suppliers;

A: the billing parameter;

B: a billing charge per unit of electricity (dollar/kW-h)

C: the total charge of consumed electricity (kW-h) of the second lighting equipment in the unit time;

P1: the power of the first lighting equipment (Watt);

P2: the power of the second lighting equipment (Watt).

For example, if the lighting equipment supplier takes 80% of the saved charge as the service charge, 20% of the saved charge is rewarded to the customer as an incentive. Supposing that the saved charge Y is 1,000 dollars, the service charge X, which is 80% of the saved charge Y, is equal to 800 dollars. It is a win-win relationship for the lighting equipment supplier to only collect 800 dollars out of the entire saved charge 1,000 dollars from the customer and reward the remaining 200 dollars of the saved charge to the customer as an incentive. With reference to FIGS. 1A and 1B, after calculating the service charge, the billing server 40 further performs the following steps.

Step S111: Determine if the service charge is received. When the service charge is received, resume step S16. Otherwise, perform step S112.

Step S112: Control the second lighting equipment to blink.

Step S113: Determine if the second lighting equipment is to be turned off. If determining that the second lighting equipment is not to be turned off, resume step S111. Otherwise, perform step S114.

Step S114: Control the second lighting equipment to turn off.

The billing server 40 in the billing method for lighting equipment can control the second lighting equipment 50 to turn on or off through the Internet 31. Therefore, when the customer fails to pay the service charge, the lighting equipment supplier can remotely control the second lighting equipment 50 to blink through the billing server 40 as a reminder for the customer to fulfill the payment obligation. However, if the customer still fails to remit the payment to the lighting equipment supplier, the lighting equipment supplier can directly turn off the second lighting equipment 50 through the billing server 40, disallowing the customer to further use the second lighting equipment 50 in response to the payment failure. For example, when the customer fails to pay the service charge to the lighting equipment supplier one month after the payment due date, the lighting equipment supplier remotely controls the second lighting equipment 50 to blink through the billing sever 40 with a starting flashing frequency about three flashes per hour. When the customer still fails to pay the service charge two months after the payment due date, the lighting equipment supplier increases the flashing frequency, such as 6 flashes per hour, through the billing server 40 to remind the customer of the due payment as a requirement of the normal use of the second lighting equipment 50. When the customer still continuously fails to remit the due payment, the lighting equipment supplier can decide whether to directly and remotely control the second lighting equipment to turn off through the billing server 40 or not, thereby ensuring management of the second lighting equipment 50, preventing the customer who fails to fulfill the obligation of paying the service charge while continuously using the second lighting equipment, and also avoiding further financial loss of the lighting equipment supplier.

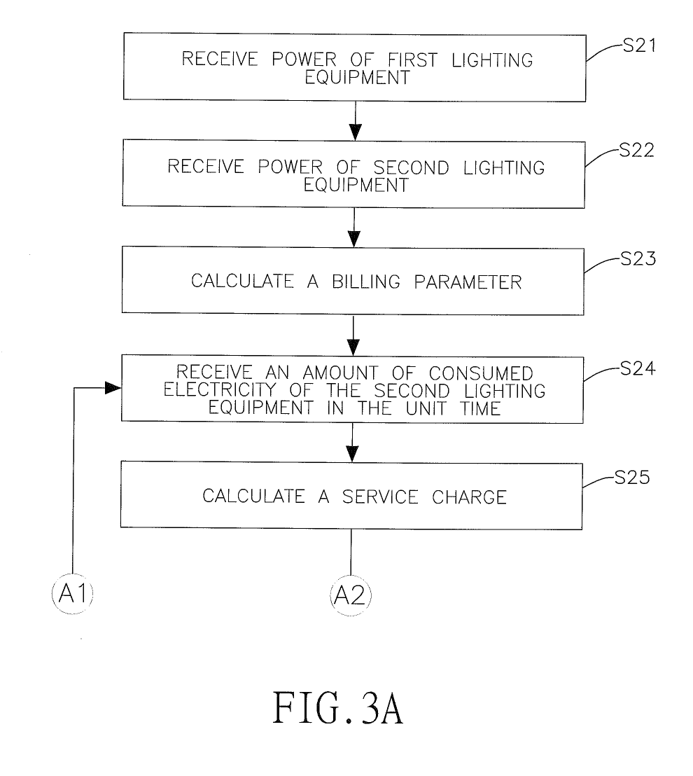

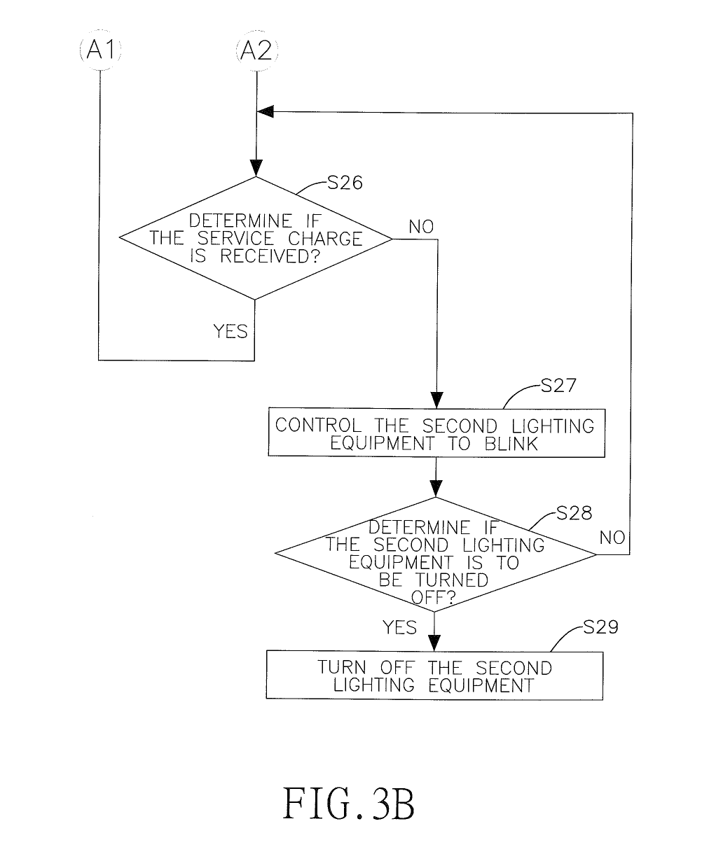

With reference to FIGS. 3A and 3B, a second embodiment of a billing method for lighting equipment in accordance with the present invention is performed by a billing server connected to first lighting equipment or second lighting equipment through the Internet, and includes the following steps.

Step S21: Receive power from first lighting equipment through the Internet.

Step S22: Receive power from second lighting equipment through the Internet. The second lighting equipment is used to replace the first lighting equipment, and the power of the first lighting equipment is greater than the power of the second lighting equipment.

Step S23: Calculate a billing parameter according to the power of the first lighting equipment and the power of the second lighting equipment.

Step S24: Receive an amount of consumed electricity of the second lighting equipment in a unit time through the Internet.

Step S25: Calculate a service charge according to the billing parameter and the amount of consumed electricity of the second lighting equipment in the unit time.

The billing server remotely manages the second lighting equipment through the Internet, not only receiving the power of the first lighting equipment and the power of the second lighting equipment through the Internet to calculate the billing parameter but also calculating the service charge after receiving the amount of consumed electricity of the second lighting equipment. Thus, the lighting equipment supplier can request customers to pay for the service charge without requiring the electric bill provided from the customers. Besides, the service charge can be obtained according to the recorded power of the first lighting equipment and the second lighting equipment. Accordingly, a fair business relationship between the lighting equipment supplier and the customers can be ensured. In the present embodiment, the billing parameter is calculated by the following formula.

$$A = \frac{P 1 - P 2}{P 2}$$

where

A: the billing parameter;

P1: the power of the first lighting equipment (Watt);

P2: the power of the second lighting equipment (Watt).

The saved charge is calculated according to the following equation.

$$Y = C \times A \times B = C \times \frac{P 1 - P 2}{P 2} \times B$$

where

Y: the saved charge out of a total charge of consumed electricity (kW-h) of the second lighting equipment in the unit time;

A: the billing parameter;

B: a billing charge per unit of electricity (dollar/kW-h);

C: the total charge of consumed electricity (kW-h) of the second lighting equipment in the unit time;

P1: the power of the first lighting equipment (Watt);

P2: the power of the second lighting equipment (Watt).

The service charge can be calculated according to the following equation.

$$X = Z \times Y = Z \times C \times A \times B = Z \times C \times \frac{P 1 - P 2}{P 2} \times B$$

Where

X: the service charge;

Y: the saved charge out of a total charge of consumed electricity (kW-h) of the second lighting equipment in the unit time;

Z: the specific percentage of the saved charge collected by lighting equipment suppliers;

A: the billing parameter;

B: a billing charge per unit of electricity (dollar/kW-h);

C: the total charge of consumed electricity (kW-h) of the second lighting equipment in the unit time;

P1: the power of the first lighting equipment (Watt);

P2: the power of the second lighting equipment (Watt).

The billing method further includes the following steps performed by the billing server.

Step S26: Determine whether the service charge is received. If the service charged is received, resume step S24.

Step S27: Control the second lighting equipment to blink.

Step S28: Determine whether to turn off the second lighting equipment. If determining not to turn off the second lighting equipment, resume step S26. Otherwise, control the second lighting equipment to turn off.

The billing server is managed by the lighting equipment supplier, and the lighting equipment supplier can further control the second lighting equipment to turn on or off through the billing server. Therefore, when identifying that a customer fails to pay the service charge, the billing server controls the second lighting equipment to blink through the Internet to remind the customer to settle the overdue payment. Moreover, the lighting equipment supplier can decide to turn off the second lighting equipment such that the customer is not able to use the second lighting equipment until the service charge is remitted. When deciding to turn off the second lighting equipment, the billing server remotely controls the second lighting equipment through the Internet to carry out the effective management of the second lighting equipment.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A billing method for lighting equipment, comprising steps of:
installing an electricity consumption meter;
recording the power of first lighting equipment with the electricity consumption meter and transmitting the power of the first lighting equipment to a billing server through the Internet;
replacing the first lighting equipment with second lighting equipment;
recording power of the second lighting equipment with the electricity consumption meter and transmitting the power of the second lighting equipment to the billing server through the Internet, wherein the power of the first lighting equipment is greater than the power of the second lighting equipment;
calculating a billing parameter using the billing server according to the power of the first lighting equipment and the power of the second lighting equipment;
recording an amount of consumed electricity of the second lighting equipment in a unit time with the electricity consumption meter, and transmitting the amount of consumed electricity to the billing server; and
calculating a service charge using the billing server according to the billing parameter and the amount of consumed electricity of the second lighting equipment in the unit time.

2. The billing method as claimed in claim 1, further comprising steps of:
using the billing server to determine if the service charge is received by the billing server;
when the service charge is received, resuming the step of recording an amount of consumed electricity of the second lighting equipment in a unit time through the billing server; and
when the service charge is not received, using the billing server to perform steps of:
controlling the second lighting equipment to blink;
determine if the second lighting equipment is to be turned off;
when determining that the second lighting equipment is not to be turned off, resuming the step of using the billing server to determine if the service charge is received by the billing server; and
when determining that the second lighting equipment is turned off, using the billing server to turn off the second lighting equipment.

3. The billing method as claimed in claim 1, wherein the billing parameter is calculated by an equation expressed by:
$$A = \frac{P 1 - P 2}{P 2}$$
where
A: the billing parameter;
P1: the power of the first lighting equipment; and
P2: the power of the second lighting equipment.

4. The billing method as claimed in claim 2, wherein the billing parameter is calculated by an equation expressed by:
$$A = \frac{P 1 - P 2}{P 2}$$
where
A: the billing parameter;
P1: the power of the first lighting equipment; and
P2: the power of the second lighting equipment.

5. The billing method as claimed in claim 1, wherein a saved charge out of a total charge of consumed electricity of the second lighting equipment in the unit time is calculated by an equation expressed by:
Y=C×A×B
where
Y: the saved charge;
A: the billing parameter;
B: a billing charge per unit of electricity; and
C: the total charge of consumed electricity of the second lighting equipment in the unit time.

6. The billing method as claimed in claim 2, wherein a saved charge out of a total charge of consumed electricity of the second lighting equipment in the unit time is calculated by an equation expressed by:
Y=C×A×B
where
Y: the saved charge;
A: the billing parameter;
B: a billing charge per unit of electricity; and
C: the total charge of the consumed electricity of the second lighting equipment in the unit time.

7. The billing method as claimed in claim 3, wherein a saved charge out of a total charge of consumed electricity of the second lighting equipment in the unit time is calculated by an equation expressed by:
$$Y = C \times \frac{P 1 - P 2}{P 2} \times B$$
where
Y: the saved charge;
B: a billing charge per unit of electricity;
C: the total charge of consumed electricity of the second lighting equipment in the unit time;
P1: the power of the first lighting equipment; and
P2: the power of the second lighting equipment.

8. The billing method as claimed in claim 4, wherein a saved charge out of a total charge of consumed electricity of the second lighting equipment in the unit time is calculated by an equation expressed by:
$$Y = C \times \frac{P 1 - P 2}{P 2} \times B$$
where
Y: the saved charge;
B: a billing charge per unit of electricity;
C: the total charge of consumed electricity of the second lighting equipment in the unit time;
P1: the power of the first lighting equipment; and
P2: the power of the second lighting equipment.

9. The billing method as claimed in claim 7, wherein the service charge can be calculated by an equation expressed by:
X=Z×Y
where
X: the service charge;
Y: the saved charge out of the total charge of the consumed electricity of the second lighting equipment in the unit time; and
Z: a specific percentage of the saved charge to be collected.

10. The billing method as claimed in claim 8, wherein the service charge can be calculated by an equation expressed by:
X=Z×Y
where
X: the service charge;
Y: the saved charge out of the total charge of consumed electricity of the second lighting equipment in the unit time;
Z: a specific percentage of the saved charge to be collected.

11. A billing method for lighting equipment performed by a billing server connected to first lighting equipment or second lighting equipment through the Internet, the billing method comprising steps of:
receiving power from first lighting equipment through the Internet;
receiving power from second lighting equipment through the Internet, wherein the second lighting equipment replaces the first lighting equipment, and the power of the first lighting equipment is greater than the power of the second lighting equipment;
calculating a billing parameter according to the power of the first lighting equipment and the power of the second lighting equipment;
receiving an amount of consumed electricity of the second lighting equipment in a unit time through the Internet; and
calculating a service charge according to the billing parameter and the amount of consumed electricity of the second lighting equipment in the unit time.

12. The billing method as claimed in claim 11, further comprising steps of:
determining if the service charge is received;
when the service charge is received, resuming the step of receiving the amount of consumed electricity of the second lighting equipment in the unit time through the Internet; and
when the service charge is not received, performing steps of:
controlling the second lighting equipment to blink;
determining whether to turn off the second lighting equipment;
when determining not to turn off the second lighting equipment, resuming the step of determining if the service charge is received; and
when determining to turn: off the second lighting equipment, turning off the second lighting equipment.

13. The billing method as claimed in claim 11, wherein the billing parameter is calculated by an equation expressed by:
$$A = \frac{P 1 - P 2}{P 2}$$
where
A: the billing parameter;
P1: the power of the first lighting equipment; and
P2: the power of the second lighting equipment.

14. The billing method as claimed in claim 12, wherein the billing parameter is calculated by an equation expressed by:
$$A = \frac{P 1 - P 2}{P 2}$$
where
A: the billing parameter;
P1: the power of the first lighting equipment; and
P2: the power of the second lighting equipment.

15. The billing method as claimed in claim 11, wherein a saved charge out of a total charge of consumed electricity of the second lighting equipment in the unit time is calculated by an equation expressed by:
Y=C×A×B
where
Y: the saved charge;
A: the billing parameter;
B: a billing charge per unit of electricity; and
C: the total charge of consumed electricity of the second lighting equipment in the unit time.

16. The billing method as claimed in claim 12, wherein a saved charge out of a total charge of consumed electricity of the second lighting equipment in the unit time is calculated by an equation expressed by:
Y=C×A×B
where
Y: the saved charge;
A: the billing parameter;
B: a billing charge per unit of electricity; and
C: the total charge of consumed electricity of the second lighting equipment in the unit time.

17. The billing method as claimed in claim 13, wherein a saved charge out of a total charge of consumed electricity of the second lighting equipment in the unit time is calculated by an equation expressed by:
$$Y = C \times \frac{P 1 - P 2}{P 2} \times B$$
where
Y: the saved charge;
B: a billing charge per unit of electricity;
C: the total charge of consumed electricity of the second lighting equipment in the unit time;
P1: the power of the first lighting equipment; and
P2: the power of the second lighting equipment.

18. The billing method as claimed in claim 14, wherein a saved charge out of a total charge of consumed electricity of the second lighting equipment in the unit time is calculated by an equation expressed by:
$$Y = C \times \frac{P 1 - P 2}{P 2} \times B$$
where
Y: the saved charge;
B: a billing charge per unit of electricity;
C: the total charge of consumed electricity of the second lighting equipment in the unit time;
P1: the power of the first lighting equipment; and
P2: the power of the second lighting equipment.

19. The billing method as claimed in claim 17, wherein the service charge can be calculated by an equation expressed by:
X=Z×Y
where
X: the service charge;
Y: the saved charge out of the total charge of consumed electricity of the second lighting equipment in the unit time; and
Z: a specific percentage of the saved charge to be collected.

20. The billing method as claimed in claim 18, wherein the service charge can be calculated by an equation expressed by:
X=Z×Y
where
X: the service charge;
Y: the saved charge of the total charge of consumed electricity of the second lighting equipment in the unit time; and
Z: a specific percentage of the saved charge to be collected.
